(19) United States
(12) Patent Application Publication
(10) Pub. No.: US 2020/0211057 A1
(43) Pub. Date: Jul. 2, 2020

(54) EXTRAPOLATED ALLOCATION OF ADVERTISEMENT BUDGETS

(71) Applicant: Oath Inc., New York, NY (US)

(72) Inventors: Deguang Kong, Sunnyvale, CA (US); Jian Yang, Palo Alto, CA (US)

(21) Appl. No.: 16/236,180

(22) Filed: Dec. 28, 2018

(51) Int. Cl. G06Q 30/02

(52) U.S. Cl. CPC G06Q 30/0249; G06Q 30/0243

(57) ABSTRACT

Advertisement budgets are often apportioned over an advertisement period, such as apportioning fixed increments of the budget over subperiods of the advertisement period. Each allocation of the budget may be used for auctions of advertisement opportunities during the subperiod. However, fixed apportioning may not be responsive to the actual user response, and manual adjustment of the budget may provide an efficient allocation in view of an advertiser's response target, resulting in overspending, underspending (wherein resulting user response fails to meet a response target), and/or inefficient allocation of the budget. Instead, a server may measure the user response during a first advertisement subperiod, extrapolate the user response over the advertisement period, and compare the extrapolated user response to the response target. Based on the comparison, budget allocation during a second advertisement subperiod may be adjusted by an allocation offset that adapts the allocation of the advertisement budget to the response target.

### BACKGROUND

Within the field of computing, many scenarios involve an advertisement budget that is to be allocated to a set of advertisement opportunities. For example, advertisement opportunities may exist on a set of web pages to be presented to users over an upcoming seven-day period, and the advertisement opportunities for each day may be auctioned at a fixed price to advertisers. An advertiser who seeks to fill the advertisement opportunities may allocate the budget over the auctions during the advertisement period in various ways. For example, the advertiser may allocate a fixed increment of the budget for each subperiod, such as allocating 14% of the total advertisement budget for each day of the seven-day period. Alternatively, the advertiser may choose other allocations based on the advertiser's projection of the user response of users over the advertisement period; e.g., a projection that the advertisements are likely to be well-received on weekdays may allocate 18% of the budget to each weekday and only 5% of the budget for each weekend day.

### SUMMARY

Fixed budget allocation of advertisements over an advertisement period may be an inflexible and inefficient allocation mechanism for advertisers who seek to allocate the budget in view of a response target. For example, the advertiser may anticipate an overall response count of user responses to the advertisements, such as a total number of impressions or click-through instances; an average response rate over the advertising period, such as the average rate at which users completely view and/or click through a presented advertisement; and/or an average response rate per budget unit, such as the number of impressions or click-throughs arising from each allocated portion of the budget. If the budget is allocated in fixed increments over the advertisement subperiods in advance of the advertisement period, the actual user response may not match the projections of the advertiser. An advertiser may monitor the budget allocation and make adjustments based on the advertiser's updated estimations, but such estimations may fail to promote the advertiser's targets. For example, the advertiser may determine that the budget allocation during a first subperiod (e.g., advertising on a Monday) produced fewer impressions or clicks than estimated, and may therefore increase the budget allocation for a second subperiod (e.g., advertising on a Tuesday). However, data may indicate that the second subperiod typically reflects a historically more favorable user response (e.g., users may be more likely to respond to advertisements on a Tuesday for this particular type of advertisement), and the advertiser's adjustment for the second subperiod may result in an overspending. Alternatively, data may indicate that spending during the second subperiod is unlikely to produce a significant increase in the user response (e.g., the advertisements may have saturated the user base and may already reach most of the interested users), such that an increased allocation during the second subperiod may spend resources without promoting the overall response toward the response target.

Presented herein are techniques that allocate a budget for advertisements over an advertisement period in a manner that flexibly promotes the allocation to meet a response target. In accordance with these techniques,

In a first example embodiment, a method is provided for allocating a budget to advertisement opportunities during an advertisement period. The method involves a server having a processor and involves executing, by the processor, instructions that cause the server to allocate a first budget allocation of the budget to advertisement opportunities over a first advertisement subperiod. The execution of the instructions also causes the server to measure a user response to advertisements presented during the advertisement opportunities during the first advertisement subperiod. The execution of the instructions also causes the server to extrapolate the user response during the first advertisement subperiod to an extrapolated user response over the advertisement period. The execution of the instructions also causes the server to compare the extrapolated user response to a response target to determine an allocation offset. The execution of the instructions also causes the server to allocate a second budget allocation of the budget, adjusted relative to the first budget allocation according to the allocation offset, to advertisement opportunities during a second advertisement subperiod.

In a second example embodiment, a method is provided for allocating a budget to advertisement opportunities during an advertisement period. The method involves a server having a processor and involves executing, by the processor, instructions that cause the server to partition the advertisement period into at least two advertisement subperiods. The execution of the instructions also causes the server to, for a first advertisement subperiod, allocate a first budget allocation of the budget to advertisement opportunities, and determine a user response to advertisements presented during the advertisement opportunities. The execution of the instructions also causes the server to compare the user response for the first advertisement subperiod to a response target for the first advertisement subperiod to determine an allocation offset that adapts the user response toward the response target. The execution of the instructions also causes the server to adjust a second budget allocation of the budget for a second advertisement subperiod, relative to the first advertisement subperiod, based on the allocation offset.

In a third example embodiment, a server is provided that allocates a budget to advertisement opportunities during an advertisement period. The server comprises a processor and a memory storing instructions that, when executed by the processor, cause the server to operate in accordance with the techniques presented herein. In particular, execution of the instructions causes the server to allocate a first budget allocation of the budget to advertisement opportunities over a first advertisement subperiod. Execution of the instructions further causes the server to measure a user response to advertisements presented during the advertisement opportunities during the first advertisement subperiod. Execution of the instructions further causes the server to extrapolate the user response during the first advertisement subperiod to an extrapolated user response over the advertisement period. Execution of the instructions further causes the server to compare the extrapolated user response to a response target to determine an allocation offset. Execution of the instructions further causes the server to allocate a second budget allocation of the budget, adjusted relative to the first budget allocation according to the allocation offset, to advertisement opportunities during a second advertisement subperiod.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

While the techniques presented herein may be embodied in alternative forms, the particular embodiments shown in the drawings are only a few such examples that are supplemental of the description provided herein. These embodiments are not to be interpreted as limiting any aspect of the invention, which is defined by the claims appended hereto.

FIG. 1 is an illustration of an example scenario involving an allocation of a budget for advertisements over an advertisement period.

FIG. 2 is an illustration of an example scenario involving an allocation of a budget for advertisements over an advertisement period in accordance with the techniques presented herein.

FIG. 3 is an illustration of a first example method of allocating a budget for advertisements over an advertisement period in accordance with the techniques presented herein.

FIG. 4 is an illustration of a second example method of allocating a budget for advertisements over an advertisement period in accordance with the techniques presented herein.

FIG. 5 is an illustration of an example scenario featuring an example server that allocates a budget for advertisements over an advertisement period in accordance with the techniques presented herein.

FIG. 6 is an illustration of a scenario featuring an example nontransitory memory device that causes a server to allocate a budget for advertisements over an advertisement period in accordance with the techniques presented herein.

FIG. 7 is an illustration of an example computing environment in which at least a portion of an embodiment of the currently presented techniques may be utilized.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and systems. Accordingly, this subject matter is not intended to be construed as limited to any example embodiments set forth herein; example embodiments are provided merely to be illustrative. Such embodiments may, for example, take the form of hardware, software, firmware or any combination thereof. A reasonably broad scope for claimed or covered subject matter is intended.

### 1. Introduction

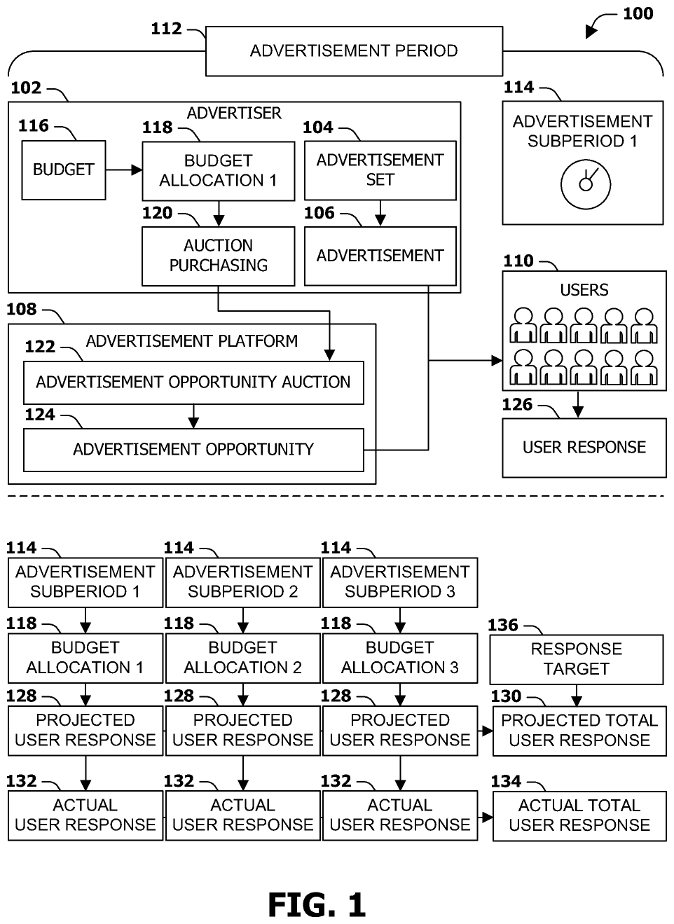

FIG. 1 is an illustration of an example scenario 100 featuring an example allocation of a budget 116 for advertisements 106 over an advertisement period 112. In this example scenario 100, an advertisement platform 108 features a set of advertisement opportunities 124 that may be filled with an advertisement 106, such as an advertisement position on a popular web page, or embedded within a popular video, or included in a popular document. In advance of an advertisement subperiod 114, the advertisement platform 1008 may offer a set of advertisement opportunities 124 during the advertisement subperiod 114 to a set of advertisers 102 through an advertisement opportunity auction 122. The set of advertisement opportunities 124 may comprise an assortment (e.g., placement of advertisements 106 over a broad set of web pages, videos, documents, etc. that generally appeal to the population) or may be targeted (e.g., placement of advertisements 106 for web pages, videos, documents, etc. that are frequently viewed by a particular demographic, such as males within the 20-29 age range). The Advertisers 102 bid on the advertisement opportunity auction 122, and the advertiser 102 with the highest bid at the closing time of the advertisement opportunity auction 122 secures the placement of advertisements 106 during the set of advertisement opportunities 124 for the advertisement subperiod 114. In this manner, a set of advertisers 102 and the advertisement platform 108 may negotiate the placement of advertisements 106 during various sets of advertisement opportunities 124 during a sequence of advertisement subperiods 114.

As shown in the example scenario 100 of FIG. 1, an advertiser 102 chooses a budget 116 for the advertisement period 112 (such as a week) and then apportions the budget 116 into individual budget allocations 118 over respective advertisement subperiods 114 (such as each day of the week). For a first budget allocation 118, the advertiser 120 may place bids at a variety of advertisement opportunity auctions 122, where a probabilistic estimate of the number of advertisement opportunity auctions 122 that are likely to be won multiplied by the bid amounts of the auctions yields a sum that approximates the budget allocation 118 during the first advertisement subperiod 114. Upon completion of the advertisement opportunity auctions 122, the advertiser 102 may provide advertisements 106 for the secured advertisement opportunities 124 to the advertisement platform 108, which may insert the advertisements 106 in the advertisement opportunities 124 for presentation to users 110.

For some advertisement campaigns, the placement of advertisements 106 in advertisement opportunities 124 may be sufficient for the advertiser 102. For example, the advertiser 102 may be satisfied with having placed one million advertisements 106 in advertisement opportunities 124 during the advertisement subperiod 114, such as the inclusion of an advertisement 106 in one million web pages that are served on a particular day. However, other advertisement campaigns may be measured by user response 126. As a first example, an advertisement 106 may be embedded in a stream of a video that is viewed one million times, but a much smaller number of users 110 may watch the video long enough to view the advertisement 106, and an even smaller number of users 110 may watch the advertisement 106 embedded in the video without skipping over the advertisement 106 to the next segment of video content. Therefore, some advertisers 102 may measure the effectiveness of advertisement placement based on impressions, or the number of instances in which users 110 actually viewed the advertisement 106, rather than the number of instances in which such users 110 merely had an opportunity to view the advertisement 106. Similar discrepancies between advertisement service and advertisement impressions arise in the context of website advertising; e.g., an advertisement 106 may be transmitted from the advertisement platform 108 to the devices of a large number of users 110, but some users 110 may utilize ad-blocking software that deliberately omits the presentation of the advertisement 106 to the user 110, while other users 110 may not see the advertisement 106 due to device incompatibility (e.g., transmission of an image-based advertisement to a device that only displays text). As a second example, an advertisement 106 may comprise an image coupled with a hyperlink to a product or service website. The advertisement may be embedded in a website that is shown a large number of users 110 who see the advertisement 106, but a much smaller number of users 110 who see the advertisement 106 may express an interest in the advertised product or service by clicking on the image or following the hyperlink to the product or service website associated with the advertisement 106. As a result, the number of impressions may be much smaller than the number of clicks exhibited by the users 110.

Because different advertisers 102 may have different measures of the success of an advertisement campaign (e.g., pages served vs. impressions vs. clicks), an advertisement platform 108 may track a user response 126 of users 110 to the advertisements 106 presented during an advertisement opportunity 124. For example, the web page served by an advertisement platform 108 to a user 110 may detect when the advertisement 106 is presented to the user 110, and/or when the user 110 takes an action that expresses interest in an advertisement 106, such as clicking on an advertisement 106. The web page may send back to the advertisement platform 108 a notification of the user response 126, and the advertisement platform 108 may notify the advertiser 102 of aggregate metrics of user response 126 during an advertisement subperiod 114. The advertiser 102 may compare the measured user response 126 during the advertisement period 112 to a response target 136, such as a target number of impressions or clicks of users 110 in response to the advertisements 106 presented over the entire the advertisement period 112.

As further shown in the example scenario 100 of FIG. 1, the allocation of the budget 116 by the advertiser 102 may be based on a projected user response 128 that the advertiser 102 estimates for each advertisement subperiod 114 based on the budget allocation 118. For example, the advertiser 102 may presume that the budget allocation 118 for each subperiod 114 exhibits a linear relationship with the number of advertisement opportunity auctions 122 won during the period; the number of advertisements 106 presented during the successful advertisement opportunities 124 won through the advertisement opportunity auctions 122; and the projected user response 128 in response to the advertisements 106. For example, for an advertisement 106 of a film that debuts in theaters on a Friday, the advertiser 102 may seek to solicit one million user responses 126 over the course of Tuesday, Wednesday, and Thursday. Recognizing that users 110 are more interested in advertisements 106 for films that are presented on weekdays closer to the weekend, the advertiser 102 may presume that 50% of auction bids result in winning the advertisement opportunity auction 122 and the accompanying advertisement opportunities 124, and that the advertisements 106 presented during such advertisement opportunities 124 demonstrate a consistent ratio of 5% click-through rate on Thursdays, a 4% click-through rate on Wednesdays, and a 3% click-through rate on Tuesdays. The advertiser 102 may therefore estimate the projected user response 128 during each period in response to advertisements based on a selected budget allocation 118 for each advertisement subperiod 114. By adjusting the budget allocations 118 for each advertisement subperiod 114 and summing the resulting projected user responses 128 of each advertisement subperiod 114, the advertiser 102 may establish an allocation for which projected total user response 130 meets the response target 136. In this manner, the advertiser 102 may allocate the budget 116 over the entire advertisement period 112 in a manner that promotes the securement of advertisement opportunities 124 and the resulting distribution of the advertisement 106 to users 110 for which the resulting user response 126 is likely to satisfy the response target 136.

However, the example scenario 100 of FIG. 1 also demonstrates a limitation with such budget allocation that may diminish the probability of the user response 126 satisfying the response target 136. If the projections of user response 126 are too high (e.g., because the advertisement 106 is poorly received, or because the advertisement 106 is poorly placed by the advertisement platform, such as in web pages that are unrelated to the advertised product or service), then the advertiser 102 exhausts the budget 116 without achieving a user response 126 that meets the response target. Conversely, if the projections of user response 126 are too low (e.g., because the advertisement 106 is more effective than expected, or because the advertisement platform 108 succeeds in presenting the advertisement 106 to users 110 who are more receptive than anticipated), then the budget 116 may be fully spent in a manner that exceeds the response target 136 (e.g., overpurchasing of advertisement opportunity auctions 122), whereas reducing the budget 116 may have resulted in an advertisement campaign that satisfied the response target 136 at a lower cost to the advertiser 102. If the budget 116 is partitioned into fixed budget allocations 118 over the course of the advertisement period 112 before the start of the advertisement period 112, and if a comparison of the actual total user response 134 to the response target 136 is performed after the advertisement period 112, then the advertiser 102 is unable to adapt the budget allocations 118 based on the ongoing advertisement campaign and is unable to adapt the advertisement campaign toward a greater probability of successfully meeting the user response 126 without overspending that results in the overpurchasing of advertisement opportunities 124.

### 2. Presented Techniques

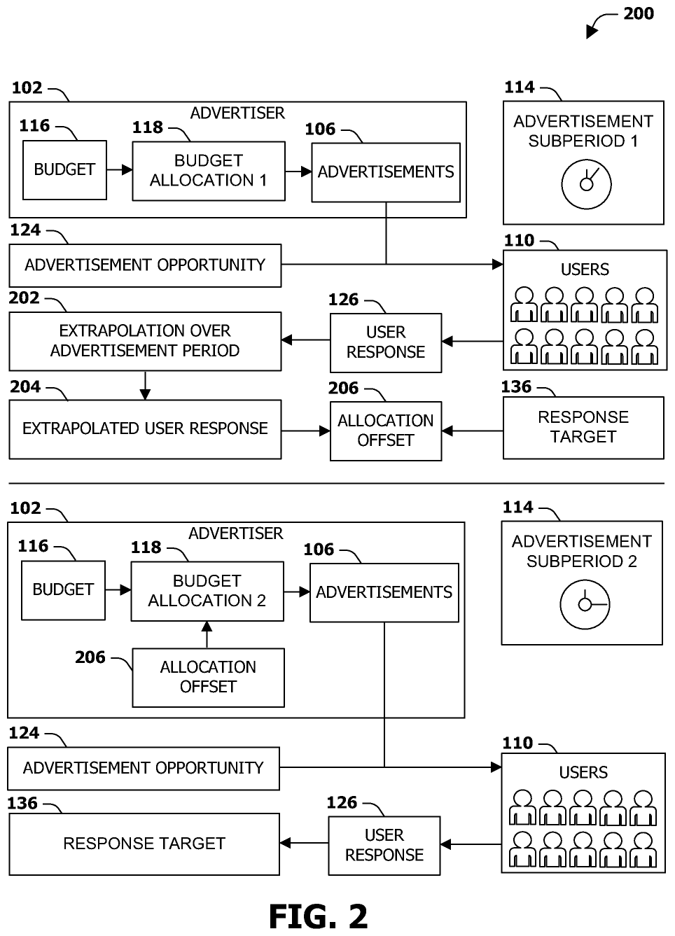

FIG. 2 is an illustration of an example scenario 200 featuring an allocation of a budget 116 for an advertisement 106 in accordance with the techniques presented herein. In this example scenario 200, an advertisement campaign of an advertiser 102 is planned over an advertisement period 112 that is partitioned into advertisement subperiods 114, and a budget 116 for the advertiser 102 is allocated into budget allocations 118 for the respective advertisement subperiods 114. As in the example scenario 100 of FIG. 1, the advertiser 102 in the example scenario 200 of FIG. 2 may commit the budget allocation 118 during the first advertisement subperiod 114 to advertisement opportunity auctions 122 of an advertisement platform 108 and may place advertisements 106 in the advertisement opportunities 124 for advertisement opportunity auctions 122 that are won by the advertiser 102. The advertiser 102 also sets a response target 136 based on user response 126 to the advertisements 106 placed in respective advertisement opportunities 124. For advertisements 106 presented during advertisement opportunities 124 a first advertisement subperiod 114, the user response 126 is measured, and an extrapolation 202 of the user response 126 during the first advertisement subperiod 114 is performed over the entire advertisement period 112. For example, if the placement of the advertisements 106 results in a results in a 10% higher user response 126 than anticipated, the extrapolation 202 of a 10% higher user response 126 may result in an increased extrapolated user response 204 over the entire advertisement period 112. The extrapolated user response 204 is compared with the response target 136 to identify an allocation offset 206, e.g., an adjustment of the budget allocation 118 for the first advertisement subperiod 114 that would have mitigated the user response 126 toward the response target 136.

As further presented in the example scenario 200 of FIG. 2, the allocation offset 206 may be applied during a second advertisement subperiod 114 to the budget allocation 118 for the second advertisement subperiod 114. During the second advertisement subperiod 114, the budget allocation 118, adjusted by the allocation offset 206, is committed to bidding on advertisement opportunity auctions 122 through an advertisement platform 108, and successful auctions result in the securement of advertisement opportunities 124 to be filled with advertisements 106. The adjustment of the budget allocation 118 by the allocation offset 206 probabilistically adjusts the number of auctions won, and the number of advertisement 106 placed in the resulting advertisement opportunities 124, such that the user response 126 for the advertisement period 112 including the user response 126 during the second advertisement subperiod 114 is closer to the response target 136 than the user response 126 for the unadjusted allocation of the budget 116. In this manner, the budget 116 for the advertisement campaign is allocated more flexibly and efficiently, responsive to the measurement of user response 126 for completed advertisement subperiods 114, to promote the efficiency of the allocation while reducing both missed response targets 136 and overpurchasing of advertisement opportunities 124 in response to the techniques presented herein.

### 3. Achievable Effects

The allocation of a budget 116 for advertisements 106 in the manner presented herein may provide a number of effects that may be presented by the currently presented techniques as compared with other techniques, including the unadjusted allocation provided in the example scenario 100 of FIG. 1.

A first effect that may be achieved by the techniques presented herein involves the allocation of a budget 116 for advertisements 106 in the context of an advertisement platform 108. In the context of online advertisements 106, advertisement opportunity auctions 122 provided by an advertisement platform 108 may occur very rapidly; some realtime bidding auctions are initiated and completed, resulting in the presentation of an advertisement 106, in the span of 100 milliseconds. The participation of an advertiser 102 in such a rapidly evolving auction process depends upon an automated technique for placing bids on advertisement opportunity auctions 122. Additionally, user response 126 may fluctuate rapidly (e.g., in the scenario in which an advertisement 106 becomes rapidly popular, such as viral marketing, the effectiveness of an advertisement 106 may rapidly increase, and/or the appeal of a particular advertisement opportunity 124 in which an advertisement 106 is placed may rapidly scale up or down in terms of popularity in a manner that consequently affects the user response 126 to advertisements 106 placed thereon). In accordance with this context, a fixed allocation of a budget 116 over the set of available advertisement opportunity auctions 122 is likely to lead to significant discrepancy between the actual user response 132 and the response target 136, including overpurchasing of advertisements 106 resulting in user response 126 that exceeds the response target 136; underpurchasing of advertisements 106 and a resulting user response 126 that fails to meet the response target 136; and/or misallocation of advertisements 106 over the advertisement subperiods 114, resulting in a lower user response 126 achieved by the budget 116 than may otherwise have been achievable.

A second effect that may be achieved by the techniques presented herein involves the determination of options for budget allocation 118 in an offline manner, e.g., before the advertisement period 112. In the example scenario 100 of FIG. 1, the budget allocation 118 for each advertisement subperiod 114 may be determined in advance, and bids for advertisement opportunity auctions 122 may be placed as each advertisement subperiod 114 occurs. As noted, advertisement opportunity auctions 122 may occur in a rapid manner, and it may be difficult to adjust the budget allocation 118 for subsequent advertisement subperiods 114 based on the performance of an advertisement 106 in a first advertisement subperiod 114; e.g., the extrapolation 202 of the extrapolated user response 204 may not be able to be completed by the time the second advertisement subperiod 114 arrives, or even by the time the second advertisement subperiod 114 concludes. The techniques presented herein may be amenable to advance planning, e.g., the forecasting of allocation offsets 206 for a second and subsequent advertisement subperiods 114 depending on a set of possible user responses 126 to the advertisements 106 presented during a first advertisement subperiod 114. That is, rather than performing the extrapolation 202 in response to the detection of the actual user response 132, the extrapolation 202 may be performed prospectively, such that the response to the actual user response 132 involves selecting the predetermined allocation offset 206 for the advertisement allocations 118 of subsequent advertisement subperiods 114. Moreover, the range of forecasted scenarios may permit advance planning in terms of other considerations, e.g., a maximum constraint on the allocation offset 206 responsive to various actual user responses 132 that constrains the maximum budget 116 that may be spent on the advertisement campaign, and/or probabilistic projections, using technique such as Monte Carlo simulations, to establish the probabilities and outcomes of the advertisement campaign and available and allocated budget 116.

A third effect that may be achieved through the techniques presented herein involves the capability of an advertisement platform 108 to satisfy a response target 136 specified by an advertiser 102. Some advertisement platforms 108 may permit an advertiser 102 to provide a budget 116 to be allocated over an advertisement period 112, and some such advertisement platforms 108 may permit the advertiser 102 to further specify the budget allocation 118 per advertisement subperiod 114. However, such advertisement platforms may offer few options for allocating the budget 116 on behalf of the advertiser 106 in a manner that promotes the fulfillment of a response target 136. That is, whether or not the budget 116 and allocation thereof selected by the advertiser 102 result in a user response 126 that satisfies a particular response target 136 may be left to the discretion of the advertiser 102. Alternatively, if the advertiser 102 delegates the allocation of the budget 116 entirely to the advertisement platform 108, the advertiser 102 may have little predictability or visibility as to the criteria upon which the allocation of the budget 116 is based, diminishing the trust of the advertiser 102 that the advertisement platform 108 is allocating the budget 116 efficiently and/or in service of the interests of the advertiser 102, including the avoidance of overpurchasing advertisements 106. The techniques presented herein may enable the advertisement platform 108 to offer a responsive budget allocation technique that the advertisement platform 108 may perform on behalf of the advertiser 102 in order to adapt the allocation of the budget 116 toward the fulfillment of the response target 136. In addition to offering flexibility and responsiveness in performing such allocation based on actual user response 132, the advertisement platform 108 may present the allocation mechanism in a transparent manner that promotes the confidence of the advertiser 102 in the allocation of the budget 116 in a manner that is both efficient and coincident with the interests of the advertiser 102. Many such technical effects may be exhibited by embodiments of the techniques presented herein.

### 4. Example Embodiments

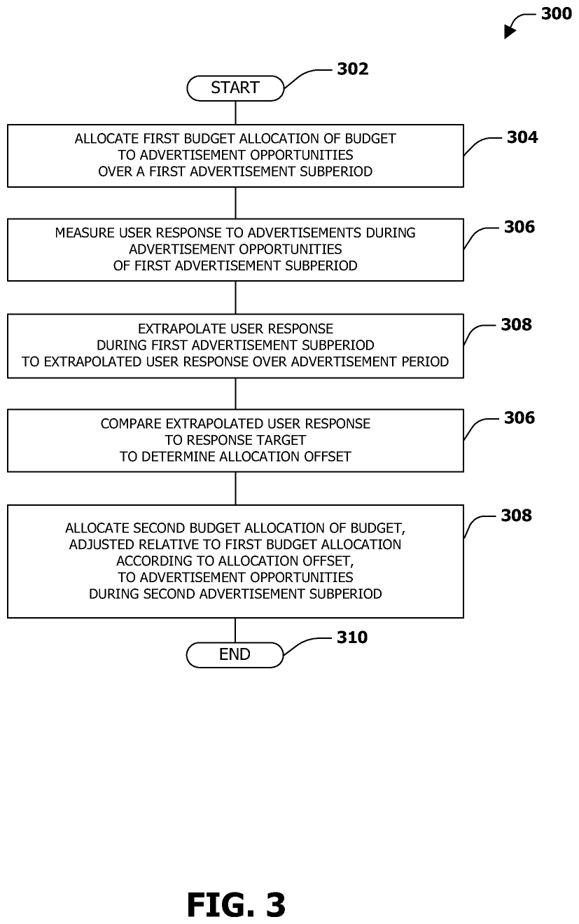

FIG. 3 presents an illustration of a first example embodiment of the techniques presented herein, illustrated as an example method 300 of allocating a budget 116 to advertisement opportunities 124 during an advertisement period 112. The example method 300 may be implemented, e.g., as instructions stored in a memory (e.g., a hard disk drive, a solid-state storage device such as a flash memory device, or a magnetic or optical disc) that, when executed on a processor of a server, cause the server to allocate budgets 116 to advertisement opportunities 124 during advertisement periods 112 in accordance with the techniques presented herein. The example method 300 begins at 302 and involves executing, by the processor, instructions that cause the server to operate in accordance with the techniques presented herein. In particular, execution of the instructions causes the server to allocate 304 a first budget allocation of the budget 116 to advertisement opportunities 124 over a first advertisement subperiod 114. Execution of the instructions further causes the server to measure 306 a user response 126 to advertisements 106 presented during the advertisement opportunities 124 during the first advertisement subperiod 114. Execution of the instructions further causes the server to extrapolate 308 the the user response 126 during the first advertisement subperiod 114 to an extrapolated user response 204 over the advertisement period 112. Execution of the instructions further causes the server to compare 310 the extrapolated user response 204 to a response target 136 to determine an allocation offset 206. Execution of the instructions further causes the server to allocate 312 a second budget allocation of the budget 116, adjusted relative to the first budget allocation according to the allocation offset 206, to advertisement opportunities 124 during a second advertisement subperiod 114. In this manner, the example method 300 enables the server to allocate the budget 116 in a reactive manner that accounts for user response 126 during the first advertisement subperiod 114 in accordance with the techniques presented herein, and so ends at 310.

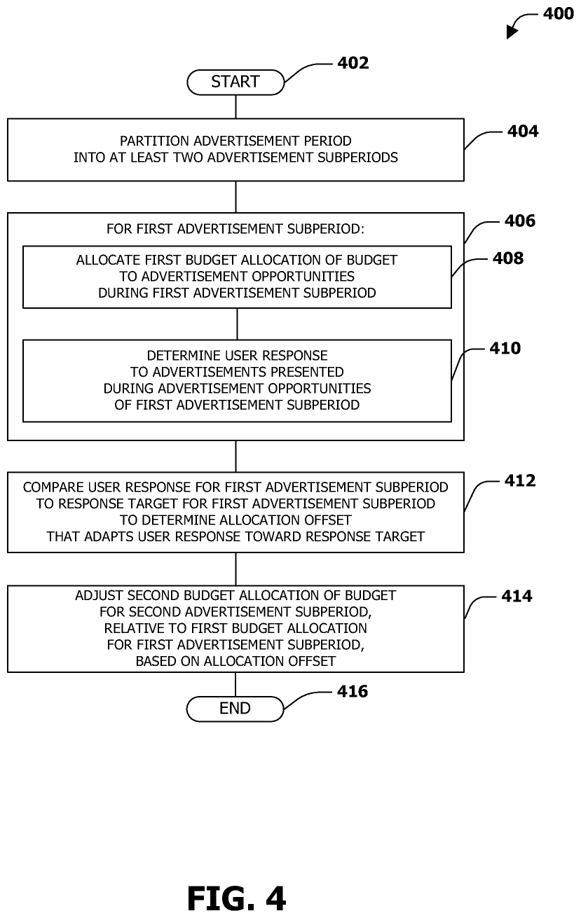

FIG. 4 presents an illustration of a second example embodiment of the techniques presented herein, illustrated as an example method 400 of allocating a budget 116 to advertisement opportunities 124 during an advertisement period 112. The example method 400 may be implemented, e.g., as instructions stored in a memory (e.g., a hard disk drive, a solid-state storage device such as a flash memory device, or a magnetic or optical disc) that, when executed on a processor of a server, cause the server to allocate budgets 116 to advertisement opportunities 124 during advertisement periods 112 in accordance with the techniques presented herein. The example method 400 begins at 402 and involves executing, by the processor, instructions that cause the server to operate in accordance with the techniques presented herein. In particular, execution of the instructions causes the server to partition 404 the advertisement period 112 into at least two advertisement subperiods 114. Execution of the instructions further causes the server to, for a first 406 advertisement subperiod 114, allocate 408 a first budget allocation of the budget 116 to advertisement opportunities 124 and determine 410 a user response 126 to advertisements presented during the advertisement opportunities. Execution of the instructions further causes the server to compare 412 the user response for the first advertisement subperiod to a response target for the first advertisement subperiod to determine an allocation offset that adapts the user response toward the response target. Execution of the instructions further causes the server to adjust 414 a second budget allocation of the budget for a second advertisement subperiod, relative to the first advertisement subperiod, based on the allocation offset. In this manner, the example method 400 enables the server to allocate the budget 116 in a reactive manner that accounts for user response 126 during the first advertisement subperiod 114 in accordance with the techniques presented herein, and so ends at 416.

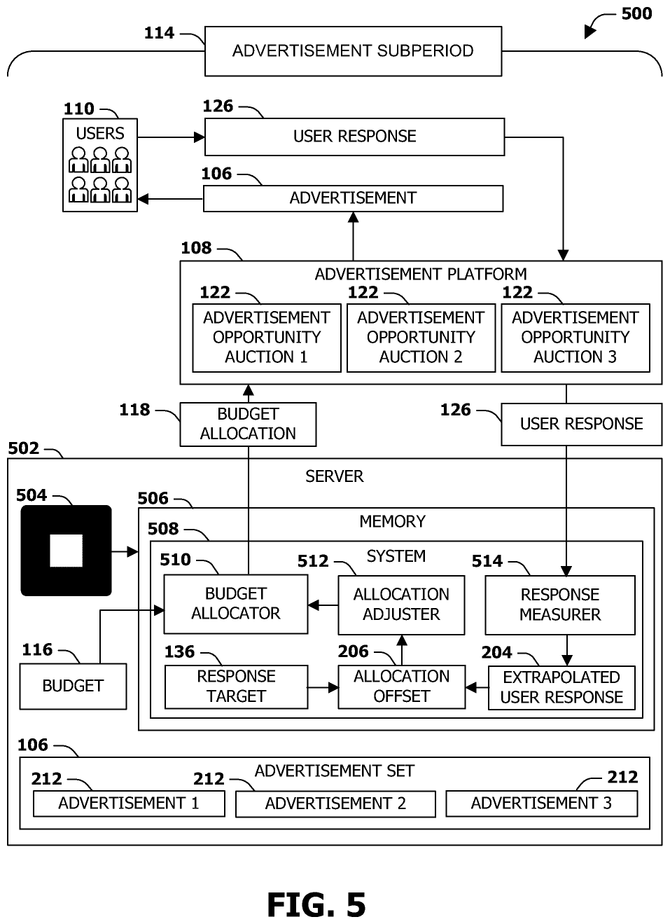

FIG. 5 is an illustration of an example scenario 500 featuring a third example embodiment of the techniques presented herein, comprising an example server 502 that allocates a budget 116 over respective advertisement subperiods 114 of an advertisement period 112. The example server 502 in this example scenario 500 interacts with an advertisement platform 108 that offers a set of advertisement opportunity auctions 122 to the example server 502, wherein the example server 502 may place bids with the advertisement platform 108 to secure advertisement opportunities 124 resulting in the placement of advertisements 106 that are presented to users 110. The advertisement platform 108 also notifies the example server 502 of the user response 126 of users 110 to presented advertisements 106, enabling the example server 502 to adjust the allocation of the budget 116 in a responsive manner in accordance with the techniques presented herein. In some scenarios, the example server 502 is part of the advertisement platform 108 that receives information from an advertiser 102 as to the allocation of the budget 116 and/or the response target 136 desired for the advertisement 106, and that flexibly adjusts the allocation of the budget 116 on behalf of the advertiser 102. In other scenarios, the example server 502 operates on behalf of an advertiser 102 and communicates with the advertisement platform 108 to place bids on advertisement opportunity auctions 122, place advertisements 106 in advertisement opportunities 124 secured thereby, and/or receive user responses 126 that the example server 502 then uses to adjust the allocation of the budget 116 on behalf of the advertiser 102.

The example server 502 comprises a process 504 and a memory 506 storing instructions that, when executed by the processor 504, cause the example server 502 to generate a system 508 of components, wherein interoperation of the components causes the example server 502 to operate in accordance with the techniques presented herein. The example system 508 includes an advertisement allocator 510 that allocates a first budget allocation 118 of the budget 116 to advertisement opportunities 124 over a first advertisement subperiod 114. The example system 508 further includes a response measurer 514 that measures a user response 126 to advertisements 105 presented during the advertisement opportunities 124 during the first advertisement subperiod 114 and extrapolates the user response 126 during the first advertisement subperiod 114 to an extrapolated user response 204 over the advertisement period 112. The example system 508 further includes an allocation adjuster 512 that compares the extrapolated user response 204 to a response target 136 to determine an allocation offset 206, such that the budget allocator 510 may allocate a second budget allocation 118 of the budget 116, adjusted relative to the first budget allocation 118 according to the allocation offset 206, to advertisement opportunities 124 during a second advertisement subperiod 114. In this manner, the example server 502 and example system 508 promote the allocation of the budget 116 over the advertisement period 112 in accordance with the techniques presented herein.

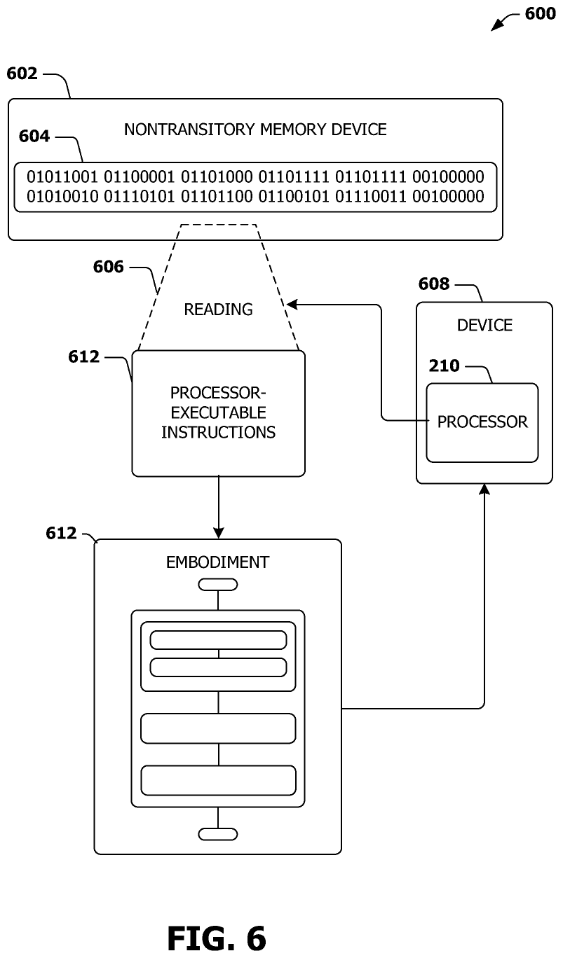

FIG. 6 is an illustration of an example scenario 600 involving a fourth example embodiment of the techniques presented herein, comprising an example nontransitory memory device 602, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 602 stores computer-readable data 604 that, when subjected to reading 606 by a reader 610 of a device 608 (e.g., a read head of a hard disk drive, or a read operation invoked on a solid-state storage device), express processor-executable instructions 612. The processor-executable instructions 612, when executed on a processor 616 of the device 608, cause the device 608 to allocate a budget 116 over an advertisement period 112, such as the example method 300 of FIG. 3 and/or the example method 400 of FIG. 4. Many such types of computer-readable devices may be provided in accordance with the techniques presented herein.

### 5. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example method 300 of FIG. 3; the example method 400 of FIG. 4; the example server 502 of FIG. 5; and/or the example nontransitory memory device 602 of FIG. 6) to confer individual and/or synergistic advantages upon such embodiments.

5.1. Scenarios

The techniques presented herein may be utilized in a variety of scenarios.

As a first such example, the techniques presented herein may be utilized with a variety of network devices 214, such as network switches, hubs, routers, access points, and repeaters. The techniques presented herein may also be utilized with a variety of servers, such as workstations, laptop and palmtop computers, mobile phones, tablets, game consoles, media players, appliances, wearable devices, and vehicle control systems. The servers may also comprise a collection of servers, such as a device “mesh” of servers that a user utilizes together, including a wristwatch, a mobile phone, and a tablet.

As a second such example, the techniques presented herein may be utilized with many types of advertisements 106 for products (e.g., computers, consumer electronics, media, clothing, sporting goods, commodities, vehicles, or real estate) and/or services (e.g., marketing, legal, medical, and/or financial services). Such advertisements 106 may be of general interest or may be targeted to certain entities, such as businesses or users within a selected demographic or location. The advertisements 106 may be passive and/or interactive, and may comprise a variety of media, such as text, still or moving graphics, and sound.

As a third such example, the advertisement opportunity 124 in which the advertisement 106 is presented may comprise a standalone advertisement, such as a billboard. The advertisement opportunity 124 may be interleaved with and/or presented adjacent to content, such as a web advertisement in which an advertisement banner is presented next to the content of a web page or a commercial presented during a program such as a radio or television broadcast or a podcast. The advertisement opportunity 124 may be integrated with the content, such as a “native” advertisement that is included in a set of items (e.g., a sponsored link that is included in a set of search results). The advertisement opportunity 124 may involve a presentation that appears apart from the content, such as a popup window that is created by a web page but in a separate browser window. The advertisement opportunity 124 may be placed within the content, such as product placement within a narrative work. The advertisement opportunity 124 may be presented in the same medium as the content (e.g., an image-based advertisement 106 that is presented with image-based content) or in a separate medium (e.g., a sound-based advertisement 106 that plays during the presentation of visual content, or an email or text message advertisement 106 that is sent to viewers of content in a web page). The advertisement opportunity 124 may comprise a single presentation of an advertisement 106 or a series of advertisements 106, such as a series of images that are presented as a gallery or as an advertisement series that is incrementally presented over time. The advertisement opportunity may cover a variety of advertisement periods 112 and advertisement subperiods 114, such as a second, a minute, a day, a week, a month, or a year. The advertisements 106 may be placed in advertisement opportunities 124 through various mechanisms, such as an advertisement opportunity auction 122 by an advertisement platform 108, an exchange or pool of advertisement opportunities 124 by content providers, or a direct placement of advertisements 106 in advertisement opportunities 124 created by the advertiser 102. Many such scenarios may be devised in which variations of the techniques presented herein may be utilized.

5.2. User Response and Extrapolation of Response Target

A second aspect that may vary among embodiments of the techniques presented herein involves the detection of the user response 126 to the presentation of an advertisement 106 and the extrapolation 22 of the user response 126 over the advertisement period 112 to a projected total user response 130.

As a first variation of this second aspect, when advertisements 106 are presented to users 110 in advertisement opportunities 124 during a first advertisement subperiod 114, the user response 126 may be measured in a variety of ways. As a first such example, the devices of the users 110 may report the presentation of an advertisement 106 to a user 110, such as the displaying of the advertisement 106 on the display of the user's device for at least a minimum period of time. As a second such example, the devices of the users 110 may report an action taken by a user 110 in response to the advertisement 106, such as hovering or dwelling on the advertisement 106, scrolling through an advertisement 106, clicking on an advertisement 106, interacting with the content of an interactive advertisement 106, saving or bookmarking an advertisement 106, or forwarding the advertisement 106 to a second user 110 in a message. As a third such example, a server of the advertiser 102 and/or advertisement platform 108 may detect the user response 126, such as the number of views of a target web page that is hyperlinked to an advertisement 106 presented to users 110. Such reporting may also include an indicator of the extent of the user response 126, such as a duration with which a user 110 viewed the advertisement 106, an amount of the advertisement 106 that the user 110 viewed (such as the length of a commercial viewed before the user 110 chose to skip the remainder), a number of clicks or interactions that a user 110 performed on a website after following a hyperlink from an advertisement 106, and/or a number of users 110 who completed a transaction after viewing the advertisement 106. As a fourth such example, user response 126 may be measured in the negative, such as the number of users 110 who chose to block, skip, or otherwise refrain from viewing or receiving the advertisement 106, and the positive user response 126 may be inferred as inversely proportional to the measured negative user response 126. As a fifth such example, user response 126 may be inferred, such as a number of website visits following the presentation of the advertisement 106 as compared with a comparable advertisement subperiod 114 that does not follow a presentation of the advertisement 106. As a sixth such example, user response 126 may be gathered from users 110, such as querying users 110 about the advertisement 106 presented during the advertisement opportunity 124.

As a second variation of this second aspect, the user response 126 during a first advertisement subperiod 114 may be extrapolated over the advertisement period 112 in a variety of ways. As a first example of this second aspect, the extrapolation 202 may comprise a linear approximation; e.g., the user response 126 during an advertisement subperiod 114 comprising a day may be multiplied by seven to extrapolate the user 126 response over an advertisement period 112 comprising a week. As a second example of this second aspect, the user response 126 may be extrapolated using a variety of mathematical techniques, such as standard deviation and Bayesian probability. As a third example of this second aspect, the extrapolation 202 may include some factors relative to one or more advertisement subperiods 114. For example, typical user response 126 on each day of the week may be estimated, and the projection of an advertisement subperiod 114 comprising a Monday may be compared with the typical user response 126 similar advertisements on Mondays, and a response offset may be extrapolated as a corresponding response offset with respect to the typical user response 126 on a Tuesday, Wednesday, etc., throughout the remainder of the advertisement period 112. In one such embodiment, extrapolating the user response 126 over the advertisement period 112 may comprise comparing the user response 126 to a historic user response for a first historic advertisement 106 (e.g., the same advertisement 106 or a similar advertisement 106 presented during a previous advertisement opportunity 124) to determine a response offset for the advertisement 106 during this advertisement subperiod 114. The extrapolation may involve identifying the extrapolated user response 204 according to the response offset. As a further example, the first historic advertisement may further comprise a first historic advertisement subperiod 114 with a first historic user response 126 and a second historic advertisement subperiod 114 with a second historic user response 126 (e.g., the user response 126, respectively, when the same or similar advertisement 106 was presented on both Monday and Tuesday of last week). Determining the response offset may further comprise comparing the user response 126 during the first advertisement subperiod 114 with the first historic user response 126 during the first historic advertisement subperiod 114, and determining the extrapolated user response 204 may further comprise comparing the second historic user response 126 during the second historic advertisement subperiod 114 with the response offset.

As a third variation of this second aspect, in some embodiments, the extrapolation 202 may occur responsive to the detection of the user response 126, such as an ad-hoc extrapolation based on live data from users 110 after the presentation of advertisements 106 during an advertisement opportunity 124.

As a fourth variation of this second aspect, an extrapolation 202 of the user response 126 over the advertisement period 112 and/or an identification of allocation offsets 206 responsive thereto may occur prospectively, e.g., in an offline manner, during or even before measuring the user response 126. Prior to the advertisement period 112, a server may generate an advertisement plan by determining, for a first projected user response 128 during the first advertisement subperiod 114, a first allocation offset 206 that may be applied to the budget allocation 118 for a second advertisement subperiod 114; and for a second projected user response 128 during the first advertisement subperiod 114, a second allocation offset 206 that may be applied to the budget allocation 118 for the second advertisement subperiod 114. Adjusting the second budget allocation 118 of the budget 116 for the second advertisement subperiod 114 may therefore involve measuring the actual user response 132 during the first advertisement subperiod 114 and selecting the allocation offset 206 of the budget allocation 118 for the second advertisement subperiod 114 according to the actual user response 132 measured during the first advertisement subperiod 114, in accordance with the advertisement plan. That is, a budget allocation 118 for each advertisement subperiod 114 may be determined in advance, and bids for advertisement opportunity auctions 122 may be placed as each advertisement subperiod 114 occurs. The extrapolation 202 may be performed in the context of advance planning, e.g., the forecasting of allocation offsets 206 for a second and subsequent advertisement subperiods 114 depending on a set of possible user responses 126 to the advertisements 106 presented during a first advertisement subperiod 114. When the actual user response 136 is measured, a predetermined allocation offset 206 for the advertisement allocations 118 of subsequent advertisement subperiods 114 may be selected based on the advance planning. Such embodiments may utilize additional considerations in such advance planning, e.g., a maximum constraint on the allocation offset 206 responsive to various actual user responses 132 that constrains the maximum budget 116 that may be spent on the advertisement campaign, and/or probabilistic projections, using technique such as Monte Carlo simulations, to establish the probabilities and outcomes of the advertisement campaign and available and allocated budget 116. Many such variations may be utilized to perform the extrapolation 202 of the user response 126 from the first advertisement subperiod 114 to a projected total user response 130 over the entire advertisement period 112 in accordance with the techniques presented herein.

5.3. Response Targets

A third aspect that may vary among embodiments of the techniques presented herein involves the specification of the response target 136 for the advertisement period 112, against which the projected total user response 130 is compared to determine the allocation offset 206 for the remaining advertisement subperiods 114.

As a first variation of this third aspect, the response target 136 may be measured as a target response total over the advertisement period 112, such as a total number of responses to be received from the users 110 (e.g., impressions, clicks, and/or transactions). Adjusting the second budget allocation 118 for the second advertisement subperiod 114 may involve adjusting the second budget allocation 118 of the budget 116 to adjust the extrapolated user response 204 toward the target response total (e.g., adjusting the purchases of advertisement opportunities 124 such that the total number of user responses 126 over the advertisement period 112, including the second advertisement subperiod 114, is likely to meet the response target 136 of total user responses).

As a second variation of this third aspect, the response target further comprises a target user response rate (e.g., a response rate of user clicks or impressions per presented advertisement 106, such as a 10% click-through rate). A user response rate during the first advertisement subperiod 114 may be extrapolated to an extrapolated user response rate over the advertisement period 112, and a second budget allocation 118 of the budget 116 may be adjusted to adjust the extrapolated user response rate toward the target user response rate.

As a third variation of this third aspect, the response target 136 may be identified as a target user response per budget unit (e.g., a number of clicks per unit of budget 116 committed to advertisement opportunities 124), and adjusting the second budget allocation 118 of the budget 116 may further comprise adjusting the second budget allocation of the budget to adjust the extrapolated user response toward the target response total per budget unit.

As a fourth variation of this third aspect, the response target 136 may be specified as a minimum target user response per budget unit (e.g., a number of transactions such as purchases completed by uses 110 in response to advertisements 106 placed in an advertisement opportunity 124), and adjusting the second budget allocation 118 of the budget 116 for a second advertisement subperiod 114 may involve limiting the adjusting to maintain the extrapolated user response above the minimum target user response per budget unit.

As a fifth variation of this third aspect, a response target 136 may be specified for one or more user demographics of users 110 to whom the advertisements 106 may be presented. For example, a first user response 126 may be measured for a first user demographic and a second user response 126 for a second user demographic. An allocation offset 206 for advertisements 106 presented to the second user demographic may be determined relative to the first user demographic (e.g., determining that advertisements 106 presented to female users 110 are to be increased by 10% relative to the presentation of advertisements 106 of male users 110 during a second advertisement subperiod 114). Adjusting the second budget allocation 118 of the budget 116 may further involve allocating, for the advertisements 106 presented during the advertisement opportunities 124 of the second advertisement subperiod 114, a first portion of the second budget allocation 118 for advertisements 116 presented to the first user demographic, and a second portion of the second budget allocation 118 for advertisements 116 presented to the second user demographic, where the second portion is selected relative to the first portion according to the allocation offset 206. For example, the budget allocation 118 during the second advertisement subperiod 114 may be partitioned into a first portion that is committed to presenting advertisements 106 presented to male users 110 and a second portion that is committed to presenting advertisements 106 presented to female users 110, and the second portion may be increased by 10% relative to the first portion, thereby probabilistically increasing the advertisements 106 presented to female users 110 during the second advertisements subperiod 114 by 10% as compared with advertisements 106 presented to male users 110 during the second advertisements subperiod 114. Many such variations may be utilized in the specification and evaluation of the response target 136 in variations of the techniques presented herein.

5.4. Allocation Offset Determination

A fourth aspect that may vary among embodiments of the techniques presented herein involves the selection of an allocation offset 206 based on a response offset based on the extrapolation 202 of a response offset over an advertisement period 112.

As a first variation of this fourth aspect, the allocation offset 206 may comprise an increase in a budget allocation 118 for a second advertisement subperiod 114 (and optionally including additional advertisement subperiods 114), e.g., if the actual user response 132 during the first advertisement subperiod 114 is below the projected user response 128 for the first advertisement subperiod 114. Alternatively, the allocation offset 206 may comprise decreasing a budget allocation 118 for a second advertisement subperiod 114, e.g., if the actual user response 132 during the first advertisement subperiod 114 is above the projected user response 128 for the first advertisement subperiod 114. As a second such example, the allocation offset 206 may adjust the second advertisement in direct proportion with the response offset during the first advertisement subperiod 114. For example, if the user response 126 during a first advertisement subperiod 114 is 5% too low, the allocation offset 206 for the second budget allocation 118 may comprise a 5% increase with an intent of raising the user response 126 by 5% during the second advertisement subperiod 114, thus placing the extrapolated user response 204 over the advertisement period 112 on track to meet the target response 136 by the end of the second advertisement subperiod 114. Alternatively, the allocation offset 206 may be distributed over two or more additional advertisement subperiods 114; e.g., if the if the user response 126 during a first advertisement subperiod 114 is 5% too low, the allocation offset 206 may comprise a 1% increase in the budget allocation 118 for each of five subsequent advertisement subperiods 114, thus placing the extrapolated user response 204 over the advertisement period 112 on track to meet the target response 136 by the end of the advertisement period 112.

As a second variation of this fourth aspect, an allocation offset 206 may be selected in the opposite direction as the response offset (e.g., a response offset representing a −10% actual user response 132 as compared with a projected user response 128 may result in a +10% allocation offset 206 as compensation). Alternatively, an allocation offset 206 may be selected in the same direction as the response offset. For example, a response offset representing a −10% actual user response 132, measured as a click-through rate per advertisement opportunity 124, may be interpreted as a sign of oversaturation of the advertisements 106, such as presenting the same advertisement 106 to a user 110 repeatedly, and the click-through rate per advertisement opportunity 124 may be increased via a −10% allocation offset 206 for subsequent advertisement subperiods 114 to reduce the effects of oversaturation.

As a third variation of this fourth aspect, an allocation offset 206 may be selected on a per-user-demographic basis. For example, a budget allocation 118 during a second advertisement subperiod 114 may be partitioned into a first portion that is committed to presenting advertisements 106 presented to male users 110 and a second portion that is committed to presenting advertisements 106 presented to female users 110, and the second portion may be increased by 10% relative to the first portion, thereby probabilistically increasing the advertisements 106 presented to female users 110 during the second advertisements subperiod 114 by 10% as compared with advertisements 106 presented to male users 110 during the second advertisements subperiod 114. As a further variation, the relative adjustment may occur in different ways, e.g., based on the specification of the response target 136. As a first such example, a response target 136 may further specify a demographic response target for respective user demographics (e.g., distinct response targets 136 for male users 110 and female users 110). If the second user response 126 for the second user demographic is lower than the first user response 126 for the first user demographic, the adjusting may involve increasing the second portion relative to the first budget allocation 118 to increase the second user response 136 for second user demographic toward the demographic response target 136 (e.g., increasing the portion of the budget allocation 118 for the second advertisement subperiod 114 for female users 110 relative to male user 110 if the user response 126 of female users 110 is below a female users response target 136 for the first advertisement subperiod 114). As a second and alternative example, a response target 136 may be specified as a target user response 126 across all user demographics. If the second user response 126 for the second user demographic is lower than the first user response 126 for the first user demographic, the adjusting may involve decreasing the second portion relative to the first budget allocation 118 to increase the second user response 136 for second user demographic toward the demographic response target 136 (e.g., if male users 110 exhibit a higher user response 126 during the first advertisement subperiod 114 than female users 110, the budget allocation 118 may be adjusted to present more advertisements 106 to male users 110 during the second advertisement subperiod 114, thereby probabilistically increasing the overall user response 126 across all user demographics during the advertisement period 112 toward the response target 136).

As a fourth variation of this fourth aspect, the allocation offset 206 may be limited in various ways. As a first such example, the allocation offset 206 may be selected only if a response offset exceeds a response offset threshold, e.g., a response offset between a projected user response 128 and an actual user response 132 during one or more advertisement subperiods 114 that exceeds a marginal response offset threshold representing typical fluctuation or noise. As a second such example, adjusting the second budget allocation 118 may further involve comparing an allocation offset 206 to an allocation offset threshold, and adjusting the second budget allocation 118 of the budget 116 according to the allocation offset 206 only if the allocation offset 206 exceeds the allocation offset threshold. Limiting the application of an allocation offset 206 may avoid adjusting budget allocations 118 too frequently, which may raise problems with budget forecasting or advertisement planning. Many such variations may be utilized to select and apply an allocation offset 206 to a budget allocation 118 for an advertisement subperiod 114 in variations of the techniques presented herein.

5.5. Advertiser Notifications and Recommendations

A fifth aspect that may vary among embodiments of the techniques presented herein involves the presentation of notifications and recommendations to an advertiser 102 in response to the formulation of allocation offsets 206 and/or the adjustment of budget allocations 118.

As a first variation of this fifth aspect, where an allocation offset 206 further involves a positive allocation offset that increases the second budget allocation 118 of the budget 116 relative to the first budget allocation 118, adjusting the second budget allocation 118 may further involve advising an advertiser 102 of the allocation offset 206 that is recommended to adjust the extrapolated user response toward the response target 136. The allocation offset 206 may be applied to adjust second budget allocation 118 relative to the first budget allocation 118 in response to acceptance by the advertiser 102 of the allocation offset 206.

As a second variation of this fifth aspect, an allocation offset 206 may involve a native allocation offset 206 that decreases the second budget allocation 118 for the second advertisement subperiod 114 relative to the first budget allocation 118 for the first advertisement subperiod 114 (e.g., a determination that user response 126 for the first advertisement subperiod 114 exceeded the response target 136, such that reducing the budget allocation 118 for the second advertisement subperiod 114 may reduce the incidence of overpurchasing in a manner that might otherwise exceed the response target 136). In response to determining a negative allocation offset 206, a server may notify an advertiser 102 of the negative allocation offset 206 that reduces the second budget allocation 118 for the second advertisement subperiod 114 and that adjusts the extrapolated user response 204 toward the response target 136 (e.g., notifying the advertiser 102 that the reduced budget allocation 118 for the second and optionally subsequent advertisement subperiods 114 is being applied without jeopardizing the fulfillment of the response target 136).

As a third variation of this fifth aspect, a server may notify an advertiser 102 of the extrapolated user response 204 over the advertisement period 112 based on the user response 126 during the first advertisement subperiod 114. For example, the server may project the probable range of user response 126 that is achievable given the budget 116 and the allocation offsets 206 applicable to the budget allocations 118 for the second and optionally subsequent advertisement subperiods 114. Such notification may enable advertisers 102 to make additional adjustments to the budget 116 and budget allocations 118, e.g., based on the advertiser's budget sensitivity, risk tolerance for failing to meet the response target 136, and/or interest in exceeding the response target 136.

As a fourth variation of this fifth aspect, a server may compare an extrapolated user response adjusted by the allocation offset 206 to the response target 136 and determine that the extrapolated user response 204, even when adjusted by the allocation offset 206, is below the response target 136 (e.g., a determination that no adjustment of the budget allocations 118 within the budget 116 is likely to meet the response target 136). Responsive to such determination, the server may notify an advertiser 102 of the determination. Such early notification may enable the advertiser 102 to take various actions, e.g., increasing the budget 116, adjusting the advertisement 106, and/or adjusting the response target 136.

As a fifth variation of this fifth aspect, a server may compare an extrapolated user response 204 adjusted by the allocation offset 206 to the response target 136, and may determine that the extrapolated user response 204 that is not adjusted by the allocation offset 206 exceeds the response target 136 (e.g., that fully allocating the budget 116 without adjusting the budget allocations 118 is likely to lead to overpurchasing of advertisement opportunities 124). The server may notify the advertiser 102 of the extrapolated user response 204 that is above the response target 136, and responsive to instructions from the advertiser 102, the server may select the extrapolated user response 204 as the response target 136 (e.g., raising the response target 136 in order to achieve a higher user response 126 for the fully spent budget 116). Alternatively, responsive to instructions from the advertiser 102, the server may maintain the response target 136 and may apply the allocation offsets 206 to the budget allocations 118 (e.g., reducing the budget 116 to meet the response target 136 while avoiding overpurchasing of advertisement opportunities 124).

As a sixth variation of this fifth aspect, where response targets 136 and/or budget allocations 118 are identified on a per-demographic basis, a server to notify an advertiser 102 that a second user response 126 for a second user demographic is lower than a first user response 126 for a first user demographic. Such notification may enable the advertiser 102 to adjust the advertisement 106 and/or the budget allocations 118 for the second and optionally subsequent advertisement subperiods 114 on a per-demographic basis. Many such variations may be utilized to notify and interact with an advertiser 102 in the application of the allocation offsets 206 of the budget allocations 118 in accordance with the techniques presented herein.

### 6. Example Computing Environment

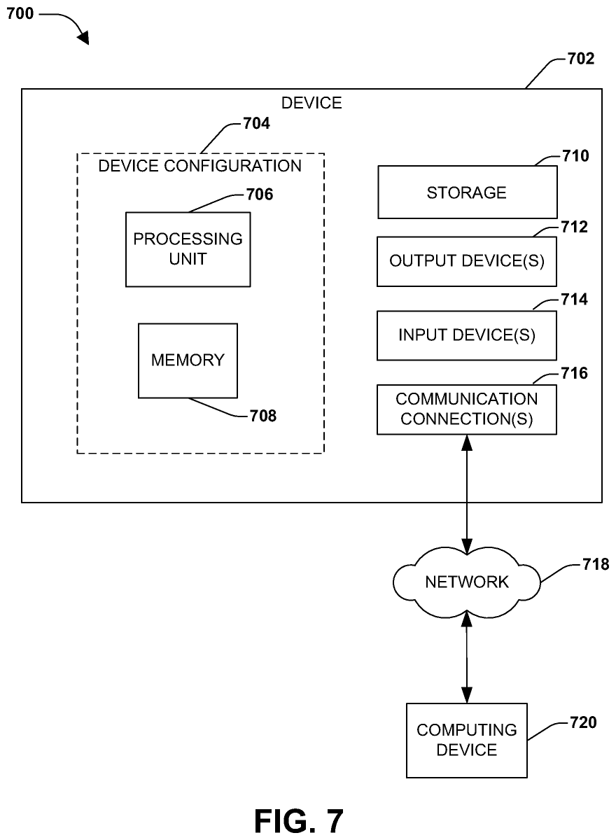

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 702 configured to implement one or more embodiments provided herein. In one configuration, computing device 702 includes at least one processing unit 706 and memory 708. Depending on the exact configuration and type of computing device, memory 708 may be volatile (such as RAM, for example), non-volatile (such as ROM, flash memory, etc., for example) or some combination of the two. This configuration is illustrated in FIG. 7 by dashed line 704.

In other embodiments, device 702 may include additional features and/or functionality. For example, device 702 may also include additional storage (e.g., removable and/or non-removable) including, but not limited to, magnetic storage, optical storage, and the like. Such additional storage is illustrated in FIG. 7 by storage 710. In one embodiment, computer readable instructions to implement one or more embodiments provided herein may be in storage 710. Storage 710 may also store other computer readable instructions to implement an operating system, an application program, and the like. Computer readable instructions may be loaded in memory 708 for execution by processing unit 706, for example.

The term “computer readable media” as used herein includes computer-readable memory devices that exclude other forms of computer-readable media comprising communications media, such as signals. Such computer-readable memory devices may be volatile and/or nonvolatile, removable and/or non-removable, and may involve various types of physical devices storing computer readable instructions or other data. Memory 708 and storage 710 are examples of computer storage media. Computer-storage storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 702 may also include communication connection(s) 716 that allows device 702 to communicate with other devices. Communication connection(s) 716 may include, but is not limited to, a modem, a Network Interface Card (NIC), an integrated network interface, a radio frequency transmitter/receiver, an infrared port, a USB connection, or other interfaces for connecting computing device 702 to other computing devices. Communication connection(s) 716 may include a wired connection or a wireless connection. Communication connection(s) 716 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 702 may include input device(s) 714 such as keyboard, mouse, pen, voice input device, touch input device, infrared cameras, video input devices, and/or any other input device. Output device(s) 712 such as one or more displays, speakers, printers, and/or any other output device may also be included in device 702. Input device(s) 714 and output device(s) 712 may be connected to device 702 via a wired connection, wireless connection, or any combination thereof. In one embodiment, an input device or an output device from another computing device may be used as input device(s) 714 or output device(s) 712 for computing device 702.

Components of computing device 702 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 702 may be interconnected by a network. For example, memory 708 may be comprised of multiple physical memory units located in different physical locations interconnected by a network.

Those skilled in the art will realize that storage devices utilized to store computer readable instructions may be distributed across a network. For example, a computing device 720 accessible via network 718 may store computer readable instructions to implement one or more embodiments provided herein. Computing device 702 may access computing device 720 and download a part or all of the computer readable instructions for execution. Alternatively, computing device 702 may download pieces of the computer readable instructions, as needed, or some instructions may be executed at computing device 702 and some at computing device 720.

### 7. Usage of Terms

Although the subject matter has been described in language specific to structural features and/or methodological acts, the subject matter defined in the appended claims is not necessarily limited to the specific features or acts described above. Rather, the specific features and acts described above are disclosed as example implementations of the claims.

Although the disclosed subject matter has been shown and described with respect to one or more implementations, equivalent alterations and modifications may occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application.

The claimed subject matter may be implemented in various ways, such as a method, an apparatus, or an article of manufacture. Each such implementation may utilize standard programming and/or engineering techniques to produce software, firmware, hardware, or any combination thereof to control a computer to implement the disclosed subject matter. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

As used herein and unless specified otherwise or clear from context, terms such as “and”, “or”, or “and/or,” may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense.

As used herein and unless specified otherwise or clear from context, the term “or” is intended to mean an inclusive “or” rather than an exclusive “or”.

As used herein and unless specified otherwise or clear from context, the terms “a,” “an,” or “the” may convey either a singular usage or a plural usage.

As used herein and unless specified otherwise or clear from context, the terms “first,” “second,” etc. are not intended to imply a temporal aspect, a spatial aspect, an ordering, etc. Rather, such terms are merely used as identifiers, names, etc. for features, elements, items, etc. For example, the terms “a first object” and “a second object” generally correspond to object A and object B, or two different objects, or two identical objects, or the same object.

As used herein and unless specified otherwise or clear from context, the terms “includes”, “having”, “has”, “with”, and variants thereof are used in either the detailed description or the claims, such terms are intended to be inclusive in a manner similar to the term “comprising.”

As used herein and unless specified otherwise or clear from context, the phrase “at least one of,” such as “at least one of A and B,” generally means A, or B, or both A and B.

As used herein and unless specified otherwise or clear from context, the term “example” is used herein to mean serving as an example, instance, illustration, etc., and not necessarily as advantageous. Any aspect or design described herein as “example” is not necessarily to be construed as advantageous over other aspects or designs. Rather, use of the word example is intended to present concepts in a concrete fashion.

As used herein and unless specified otherwise or clear from context, the term “based on” may be understood as not necessarily intended to convey an exclusive set of factors and may, instead, allow for existence of additional factors not necessarily expressly described, again, depending at least in part on context.

As used herein and unless specified otherwise or clear from context, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As used herein and unless specified otherwise or clear from context, the term “article of manufacture” as used herein is intended to encompass a computer program accessible from any computer-readable device, carrier, or media.

1. A method of allocating a budget to advertisement opportunities during an advertisement period, the method involving a server having a processor and comprising:
executing, by the processor, instructions that cause the server to:
allocate a first budget allocation of the budget to advertisement opportunities over a first advertisement subperiod;
measure a user response to advertisements presented during the advertisement opportunities during the first advertisement subperiod;
extrapolate the user response during the first advertisement subperiod to an extrapolated user response over the advertisement period;
compare the extrapolated user response to a response target to determine an allocation offset; and
allocate a second budget allocation of the budget, adjusted relative to the first budget allocation according to the allocation offset, to advertisement opportunities during a second advertisement subperiod.

2. The method of claim 1, wherein extrapolating the user response further comprises:
comparing the user response to a historic user response for a first historic advertisement to determine a response offset for the advertisement; and
identifying the extrapolated user response according to the response offset.

3. The method of claim 2, wherein:
the first historic advertisement further comprises a first historic advertisement subperiod with a first historic user response and a second historic advertisement subperiod with a second historic user response;
determining the response offset further comprises: comparing the user response during the first advertisement subperiod with the first historic user response during the first historic advertisement subperiod; and
determining the extrapolated user response further comprises: comparing the second historic user response during the second historic advertisement subperiod with the response offset to determine the extrapolated user response.

4. The method of claim 1, wherein:
the response target further comprises a target response total over the advertisement period; and
adjusting the second budget allocation of the budget further comprises: adjusting the second budget allocation of the budget to adjust the extrapolated user response toward the target response total.

5. The method of claim 1, wherein:
the response target further comprises a target user response rate;
extrapolating the user response further comprises: extrapolating a user response rate during the first advertisement subperiod to an extrapolated user response rate over the advertisement period; and
adjusting the second budget allocation of the budget further comprises: adjusting the second budget allocation of the budget to adjust an extrapolated user response rate toward the target user response rate.

6. The method of claim 1, wherein:
the response target further comprises a target user response per budget unit; and
adjusting the second budget allocation of the budget further comprises: adjusting the second budget allocation of the budget to adjust the extrapolated user response toward the target response total per budget unit.

7. The method of claim 1, wherein:
the response target further comprises a minimum target user response per budget unit; and
adjusting the second budget allocation of the budget further comprises: limiting the adjusting to maintain the extrapolated user response above the minimum target user response per budget unit.

8. The method of claim 1, wherein:
measuring the user response further comprises: measuring a first user response for a first user demographic and a second user response for a second user demographic;
determining the allocation offset further comprises: determining an allocation offset for advertisements presented to the second user demographic relative to the first user demographic; and
adjusting the second budget allocation of the budget further comprises: allocating for advertisements during the second advertisement subperiod:
a first portion of the second budget allocation for advertisements presented to the first user demographic; and
a second portion of the second budget allocation, adjusted relative to the first portion according to the allocation offset, for advertisements presented to the second user demographic.

9. The method of claim 8, wherein:
the second user response for the second user demographic is lower than the first user response for the first user demographic;
the response target further comprises a demographic response target for respective user demographics; and
adjusting the second portion further comprises: increasing the second portion relative to the first budget allocation to increase the second user response for second user demographic toward the demographic response target.

10. The method of claim 9, wherein executing the instructions further causes the server to notify an advertiser that the second user response for the second user demographic is lower than the first user response for the first user demographic.

11. The method of claim 8, wherein:
the second user response for the second user demographic is higher than the first user response for the first user demographic;
the response target further comprises a target user response across all user demographics; and
adjusting the second portion further comprises: increasing the second portion relative to the first budget allocation to increase the user response across all user demographics toward the target user response.

12. The method of claim 1, wherein adjusting the second budget allocation further comprises:
comparing the allocation offset to an allocation offset threshold; and
responsive to the allocation offset exceeding the allocation offset threshold, adjusting the second budget allocation of the budget according to the allocation offset.

13. The method of claim 1, wherein:
the allocation offset further comprises a positive allocation offset that increases the second budget allocation of the budget relative to the first budget allocation; and
adjusting the second budget allocation further comprises:
advising an advertiser of the allocation offset to adjust the extrapolated user response toward the response target; and
responsive to acceptance by the advertiser of the allocation offset, adjusting the second budget allocation of the budget relative to the first budget allocation according to the allocation offset.

14. The method of claim 1, wherein:
the allocation offset further comprises a negative allocation offset that decreases the second budget allocation of the budget relative to the first budget allocation; and
executing the instructions further causes the server to notify an advertiser of the allocation offset that reduces the second budget allocation of the budget while maintaining the extrapolated user response toward the response target.

15. The method of claim 1, wherein executing the instructions further causes the server to notify an advertiser of the extrapolated user response.

16. The method of claim 1, wherein executing the instructions further causes the server to:
compare the extrapolated user response adjusted by the allocation offset to the response target; and
responsive to a determination that the extrapolated user response adjusted by the allocation offset is below the response target, notifying an advertiser of the determination.

17. The method of claim 1, wherein executing the instructions further causes the server to:
compare the extrapolated user response adjusted by the allocation offset to the response target; and
responsive to a determination that the extrapolated user response that is not adjusted by the allocation offset exceeds the response target:
notify an advertiser of the extrapolated user response above the response target; and
responsive to an instruction from the advertiser to raise the response target to the extrapolated user response, select the extrapolated user response as the response target.

18. A method of allocating a budget to advertisement opportunities during an advertisement period, the method involving a server having a processor and comprising:
executing, by the processor, instructions that cause the server to:
partition the advertisement period into at least two advertisement subperiods;
for a first advertisement subperiod:
allocate a first budget allocation of the budget to advertisement opportunities, and
determine a user response to advertisements presented during the advertisement opportunities;
compare the user response for the first advertisement subperiod to a response target for the first advertisement subperiod to determine an allocation offset that adapts the user response toward the response target; and
adjust a second budget allocation of the budget for a second advertisement subperiod, relative to the first advertisement subperiod, based on the allocation offset.

19. The method of claim 18, wherein:
determining the allocation offset further comprises:
prior to the advertisement period, generating an advertisement plan comprising:
for a first projected user response during the first advertisement subperiod, determining a first allocation offset for the second advertisement subperiod, and
for a second projected user response during the first advertisement subperiod, determining a second allocation offset for the second advertisement subperiod; and
adjusting the second budget allocation of the budget further comprises:
measuring the user response during the first advertisement subperiod; and
selecting the allocation offset according to the user response measured during the first advertisement subperiod and the advertisement plan.

20. A server that allocates a budget to advertisement opportunities during an advertisement period, the server comprising:
a processor; and
a memory storing instructions that, when executed by the processor, cause the server to:
allocate a first budget allocation of the budget to advertisement opportunities over a first advertisement subperiod;
measure a user response to advertisements presented during the advertisement opportunities during the first advertisement subperiod;
extrapolate the user response during the first advertisement subperiod to an extrapolated user response over the advertisement period;
compare the extrapolated user response to a response target to determine an allocation offset; and
allocate a second budget allocation of the budget, adjusted relative to the first budget allocation according to the allocation offset, to advertisement opportunities during a second advertisement subperiod.
